(19) United States
(12) Patent Application Publication
(10) Pub. No.: US 2011/0005389 A1
(43) Pub. Date: Jan. 13, 2011

(54) PLANT AND PROCESS FOR RECOVERING CARBON DIOXIDE

(76) Inventors: Paul Anthony Webley, Victoria (AU); Jun Zhang, Victoria (AU)

Correspondence Address: Ballard Spahr LLP, SUITE 1000, 999 PEACHTREE STREET, ATLANTA, GA, 30309-3915, US

(21) Appl. No.: 12/746,972

(22) PCT Filed: Dec. 12, 2008
(86) PCT No.: PCT/AU08/01831

§ 371 Date: Aug. 31, 2010

Related U.S. Application Data
(60) Provisional application No. 61/015,039, filed on Dec. 19, 2007.

(30) Foreign Application Priority Data
Dec. 12, 2007 (AU) 200706738

(51) Int. Cl. B01D 53/047

(52) U.S. Cl. 95/26; 95/96; 95/42

(57) ABSTRACT

The present invention relates to a process and plant for the recovery of carbon dioxide from a gas stream by means of pressure swing adsorption using an adsorbent, such as X or Y type Zeolite adsorbents. The gas feed stream suitably has a moderate concentration of carbon dioxide, such as gas emitted from the filling bowl of the carbonated drinks bottling plant and is recovered without rinsing or purging the adsorbent with a high purity carbon dioxide gas stream. The process therefore provides the advantage of being capturing carbon dioxide from the effluent that would otherwise be emitted to the atmosphere and captures the carbon dioxide in a manner that minimises operational and capital expenditure. The present invention also relates to a process for utilizing one dry stream from a gas separation unit (adsorption or membrane process) to conduct evaporative cooling of water, which is used as the water in a liquid ring vacuum pump thereby decreasing the vacuum level and improving the performance.

### FIELD OF THE PRESENT INVENTION

The present invention relates to a process and plant for the recovery of carbon dioxide from a gas such as the waste gas emitted from a filling bowl of a beverage bottling plant. The invention also relates to the use of a waste product stream that is generated in the plant to cool a cooling water by evaporation and use of the cooling water to improve the operation of a liquid ring vacuum pump used to recover carbon dioxide in the gas separation plant.

### BACKGROUND OF THE PRESENT INVENTION

Carbonated soft drinks consume a significant amount of carbon dioxide and a great amount of carbon dioxide is released into the atmosphere, mainly during the filling process. It is widely acknowledged that carbon dioxide is a major greenhouse gas which contributes to global warming. There are both environmental and financial benefits to recovering the carbon dioxide emitted from filling bowls, especially with many countries on the verge of imposing carbon tax. For the separation of carbon dioxide, numerous approaches, including cryogenic separation, chemical Absorption, membrane and pressure/vacuum swing adsorption, have been established in different scenarios and applications. Among the various techniques of CO₂ separation, pressure/vacuum swing adsorption, due to its energy advantage, has been applied in many situations and in different forms. In these cyclic adsorption techniques, a stream of feed gas containing carbon dioxide and other gases is passed through an adsorbent-packed fixed-bed/moving bed to adsorb CO₂ onto the adsorbent. The CO₂ is then recovered through a reduction in pressure, often produced with a vacuum pump. In this process, it is usual to employ a purge/rinse step before the pressure reduction to displace non-CO₂ gases in the bed—this rinse can be done with either the CO₂ product (“heavy” purge) or CO₂-lean stream (“light” purge) purge or both. Typically, for CO₂ recovery, a heavy purge step is used.

Separation processes utilizing the principle of pressure/vacuum swing adsorption has been described in numerous publications. For example, JP 2002079052 describes a method and system using pressure/temperature swing adsorption (PTSA) to recover CO₂ at an elevated temperature in which adsorption occurs at a temperature range of 400˜650° C. and desorption at 700˜850° C. A journal article entitled “Pre-combustion CO₂ Capture Using Adsorbent and Methane Steam Reforming,” pp. 252-254, by K. Nakagawa, M. Kato, Journal of the Ceramic Society of Japan, Vol. 113 (3)(2005) describes a pre-combustion high temperature CO₂ capture process using metal oxides Impregnated ceramic adsorbent for integrated gasification coal combustion (IGCC). U.S. Pat. No. 5,917,136 also describes a pressure swing adsorption process using modified alumina adsorbents at a temperature ranging from 100° C. to 500° C. The US patent suggests that water has little influence on such materials. U.S. Pat. No. 6,322,612 describes a wet high-temperature gas process that separates CO₂ from a wet feed gas stream at a temperature of 150° C.˜450° C. U.S. Pat. No. 5,917,136 describes a process in which a family of adsorbents, including K₂CO₃ promoted hydrotalcite, Na₂O impregnated alumina, or double salt extrudates, were utilized as adsorbents in the adsorption/desorption stages and offers the advantage of being very reversible in wet conditions.

U.S. Pat. No. 5,938,819 describes a process for removing CO₂ from methane using natural clinoptilolite. The feed gas CO₂ concentration ranges from 1% to 75% and adsorption pressure ranges from 1 to 200 psig, wherein higher feed pressure increases the product purity. Dry air was used to regenerate the adsorbent. A purge step is also included in this process.

JP 2004-202393 describes a PTSA method that separates CO₂ where the adsorption is carried out at a temperature in the range of 50° C.˜100° C. and desorption is carried out at a temperature at 85° C.˜335° C. and the desorption pressure is 0.001 bar˜1 bar. A journal article entitled “Technology for Removing Carbon Dioxide from Power Plant Flue Gas by the Physical Adsorption Method”, M. Ishibashi, H. Ota. Et al., Energy Conversion and Management, Vol 37, pp. 929-933, 1996 also describes a similar method.

U.S. Pat. No. 4,726,815 describes a CO₂ recovery process with moisture pre-treatment. Molecular sieve activated carbon was used and a purge step is also included to purify the product. Evacuation pressure is 50 Torr and adsorption temperature ranges from 20° C. to 40° C. The heating effect of water removal was taken into account.

JP 2005-262001 describes a dual-reflux pressure swing adsorption process with intermediate feed and compulsory temperature control.

JP 2003-1061 describes a method to concentrate the CO₂ (5˜15%) emitted from flue gas to 20%-50%, using activated carbon as the adsorbent with a four-step cycle. In this method, counter-current air rinse was used to clean the vessel and adsorption pressure and desorption pressure are around 17.4 psia and 22.2 inch Hg. vacuum. The method aims to raise the CO₂ concentration so as to prepare the gas for further concentration to 99% in a secondary separation process.

JP 10-128059 describes a two-stage vacuum swing adsorption process with pre-treatment of moisture, SOₓ and NOₓ. Heat utilization was also optimized. Flue gas with 8-15% carbon dioxide was processed with adsorption pressure 790-810 Torr and desorption pressure 30 Torr. Pressure equalization and purge steps were also included. High purity and recovery were achieved.

Furthermore, a research paper entitled “Stripping PSA Cycles for CO₂ Recovery from Flue Gas at High Temperature Using a Hydrotalcite-Like Adsorbent”, S. Reynolds, A. Ebner and J. Ritter, Industry & Engineering and Chemistry Research, Vol 45, pp. 4278-4294 (2006) provides a very good review of P/VSA cycles for CO₂ separation. Interestingly, also surprisingly, in each of these techniques for CO₂ separation, pressurization, adsorption, pressure equalization, heavy purge (heavy reflux), light reflux, evacuation/blow-down are generally included although in different combinations to cater for different purposes. Especially, for heavy product purge/pressurization and light reflux/pressurization, at least one of them is utilized in those separations to control the gas front.

In the CO₂ recovery processes described above, the waste stream produced is often very dry since the water is usually recovered in the CO₂ product stream. This dry waste stream has evaporative cooling ability. Evaporative cooling is a process utilizing the evaporative potential of a dry stream to cool a liquid by direct contact typically in a counter-current contacting device such as a cooling tower. The use of this feature to provide cooled water which in turn may be used to cool process streams within the plant is common. For example, cooling water may be used in a compressor aftercooler in the gas separation industry for the front-end purification (FEP) of air feed (Frank G. Kerry, 2006).

U.S. Pat. No. 5,306,331 by Air Products Inc discloses a process to utilize the cooling power of dry membrane permeation gas stream to conduct evaporative cooling of the cooling water for the compressor after-cooler which is used to cool the feed air and drop the dew point for a consequent air separation process.

U.S. Pat. No. 5,345,771 discloses an improved process for recovering one or more condensable compounds from an inert gas-condensable compound vapor mixture, wherein a liquid ring vacuum pump is used to condense and recover condensable compounds (methanol, benzene, toluene and other organic compounds).

However, the recovery of carbon dioxide emitted from the filling bowl at a bottling plant, is intrinsically different from the known applications mentioned above. In this particular situation, the carbon dioxide concentration is high (>50%) and saturated with moisture at low temperatures. In order for the gas product to be fed back to the filling system of a bottling plant the gas will require purification to a food-grade of >99% CO₂. The prior art techniques described above are not suitable for this application and it is an object of the present invention to provide a process suitable for this application.

### SUMMARY OF THE INVENTION

According to the present invention there is provided a pressure swing adsorption processes for recovering carbon dioxide from a feed gas stream, the process including the steps of:

a) adsorbing CO₂ onto an adsorbent from a feed gas stream at a particular or known pressure so as to convert the feed gas stream into a waste gas stream that is lean in carbon dioxide; and

b) desorbing CO₂ from the adsorbent loaded with CO₂ in step a) by exposing the loaded adsorbent to a pressure below the pressure of the feed gas so as produce a stream that is relatively rich in CO₂;

wherein the process is carried out without purging or rinsing loaded adsorbent of step a) with a high purity carbon dioxide gas stream as an intermediate step between steps a) and b).

The term “high purity gas stream” throughout this specification means a gas stream containing at least 90% CO₂ by weight and suitably at least 98 or 99% CO₂ by weight.

In an embodiment, the feed gas contains CO₂ at an amount equal to or greater than 50% by weight.

Suitably, the feed gas stream contains from 50 to 90% CO₂ by weight. Even more suitably, the feed gas stream contains equal to, or greater than, 70% CO₂ by weight.

The feed gas may also contain any one or a combination of moisture (H₂O), N₂, O₂ or any other trace elements. In the situation where the feed gas stream contains moisture, suitably the feed gas is saturated with water vapour.

In an embodiment, the adsorbent is contained in an adsorber vessel and the gas feed is supplied to the adsorber vessel at a pressure ranging from atmospheric pressure to 10 bar gauge. Suitably, the feed gas is supplied to the adsorber vessel at a pressure of up to 1 bar gauge. Although the vessel will have a pressure differential along the length of the vessel, it follows that step a) is carried out in the vessel at pressure substantially in the range of atmospheric to 10 bar gauge.

In an embodiment, the feed gas exposed to the adsorbent is at a temperature of less than or equal to 100° C. and suitably, in the range from 10 to 40° C.

In an embodiment, the feed gas enters a lower end of the vessel and the stream lean in carbon dioxide is discharged from an upper end of the vessel.

In an embodiment, the feed gas stream is a gas emitted from the filling bowl of a carbonated drinks bottling plant.

The adsorbent may be any suitable adsorbent including zeolites, aluminas, silica gels, activated carbons, or any other solid granular material that can selectively adsorb CO₂ over non-CO₂ species in the gas stream. Many adsorbents such as zeolites or aluminas or silica gel will also adsorb water from the gas stream.

The stream lean in CO₂, also known as effluent or waste gas, may be sent to a waste tank and either vented to atmosphere or sent to further downstream processing.

In an embodiment, the waste gas stream, may be contacted directly with cooling water in a suitable gas/liquid contacting device, such as a packed column or spray tower to cool the cooling water through the evaporative power of the waste gas. The cooling water may reach the wet bulb temperature of the waste gas stream.

In an embodiment, the cooling water (produced through evaporative cooling described above) may be used to cool a liquid-ring vacuum pump which is operated to carry out, at least in part, desorption of CO₂ according to step b) of the process by pressure reduction. The effect of lowering the water temperature in the liquid-ring vacuum pump is to reduce the power required by the vacuum pump and/or to permit a lower vacuum level to be achieved by the liquid-ring vacuum pump. Lower vacuum levels result in higher purity CO2 product streams.

In an embodiment, the rich product stream contains equal to, or greater than, 90% CO₂ by weight and suitably, equal to, or greater than, 95, 98 or 99% CO₂ by weight.

Although step b) may involve the adsorbent being exposed to any pressure reduction that results in the desorption of CO₂, suitably step b) involves exposing the adsorbent to pressure below atmospheric pressure. Even more suitably, step b) involves exposing the adsorbent to pressure in the range of 2 kPa absolute to 90 kPa absolute, and even more suitably in the range of the 2-50 kPa absolute.

In an embodiment, step b) involves reducing the pressure by means of either one or a combination of a vacuum pump or a blower.

In an embodiment, the adsorbent is contained in two or more than two columns or vessels, and steps a) and b) are carried out on the adsorbent in each vessel in an out of phase cyclic manner in which steps a) and b) respectively are carried out in one of the vessels over a period and steps b) and a) respectively are carried out in another one of the vessels over the same period, or in another period. For example, steps a) and b) are carried out in each vessel consecutively such that while step a) is carried out on the adsorbent in a first vessel, step b) is carried out on the adsorbent in a second vessel. In another example, steps a) and b) are carried out disjunctively, for instance, step a) is carried out in one vessel while step b) is yet to commence or has been completed in the other vessel. Similarly, step b) is carried out in one vessel while step a) is yet to commence or has been completed in the other vessel. One of the advantages this provides is that a substantially continuous stream of rich CO₂ can be obtained by continuously alternating from which vessel the product stream rich CO₂ is obtained.

Throughout this specification the terms “column” and “vessel” are used synonymously and also embrace a reactor and chamber.

In the situation where two or more vessels contain the adsorbent, suitably the process also includes a further step of interconnecting the vessels in fluid communication after steps a) and b), or immediately after steps a) and b) have been carried out on either one of the respective vessels. For example, in the situation where the first vessel is subject to step a) and the second vessel is subject to step b), connecting the vessels in fluid communication will result in an initial pressure reduction in the first vessel by gas flowing from the first vessel to the second vessel. Similarly in the situation where the first vessel is subject to step b) and the second vessel is subject to step a), connecting the vessels in fluid communication will result in an initial pressure reduction in the second vessel by gas flowing from the second vessel to the first vessel and, in turn, desorbing CO₂ from the absorbent in the second vessel and absorbing CO₂ onto the adsorbent in the first vessel. One of the advantages of this preferred aspect of the present invention is that interconnecting the vessels in this manner is that it lowers the energy load on the vacuum pumps or blowers that are used to depressurize vessels containing loaded adsorbent. In addition, interconnecting the vessels in this manner avoids loss of CO₂ that has been adsorbed onto the adsorbent to the atmosphere and, therefore, maximizes CO₂ recovery.

In an alternative embodiment in which two or more vessels are provided, the process includes interconnecting the vessels in fluid communication in which at least one of steps a) and b) is at the end of being carried out (or has been completed), whereby when step a) has or is being carried out in one of the vessels, communication between the vessels facilitates at least partial depressurization of the respective vessel from the operative pressure of step a), and when step b) has or is being carried out in one of the vessels, communication between the vessels facilitates at least partial repressurization of the respective vessel from the operative pressure of step b).

In an embodiment, the vessels are connected in the fluid communication between each cycle of adsorbing and desorbing of CO₂ for a period of at least 1 second, and suitably in the range of the 1 to 4 seconds and even more suitably approximately 2 seconds.

In an embodiment, step a) is carried out for a period of at least 5 seconds and suitably in the range of 5 to 15 seconds and even more suitably approximately 10 seconds.

In an embodiment, step b) is carried out for a period of at least 5 seconds and suitably in the range of 5 to 15 seconds and even more suitably approximately 10 seconds.

In an embodiment, step a) involves contacting the feed gas with adsorbent packed into a bed in one of the vessels. The process may also involve discharging from the same vessel in which step a) is being carried out a stream lean in CO₂.

According to the present invention there is also provided a pressure swing adsorption process for recovering of carbon dioxide from a feed gas stream, the process including the steps of:

a) adsorbing CO₂ onto an adsorbent from a feed gas stream containing equal to or greater than 50% CO₂ by weight so as to convert the feed gas stream into a stream lean in CO₂; and

b) desorbing CO₂ from adsorbent loaded with CO₂ in step a) by exposing the loaded adsorbent to a pressure below a pressure of the feed gas so as to produce a rich stream having a CO₂ content that is equal to greater than 95% by weight.

Suitably, the process is carried out without purging or rinsing loaded adsorbent of step a) with a high purity carbon dioxide gas stream as an intermediate step between steps a) and b).

The pressure swing adsorption process described in the two paragraphs immediately above may also include any one or a combination of the process features described above.

According to the present invention there is also provided a plant for recovering of CO₂ from a feed gas stream, wherein the plant is operated according to the process described in any of the paragraphs above. The plant comprising:
i) two or more than two vessels, each vessel containing a bed of CO₂ adsorbent material;
ii) feed means that can be selectively opened and closed to supply the feed gas to the vessel in a consecutive manner, one after the other;
iii) a suction or vacuum pump that can selectively apply suction to the beds contained in the vessels one after the other, and in an out-of-phase operation with the feed means such that when the feed means supplies feed gas to one of the vessels, the suction or vacuum pump applies suction to another vessel;
iv) a fluid communication means that allows fluid communication between the vessels at desired instances.

In use, suitably the feed means may be operated to allow the feed gas to be supplied to the first vessel and simultaneously, the suction pump applies suction to the second vessel. After a predetermined period, operation of the feed means and suction pump is changed such that the feed means feeds gas to the second vessel and the suction pump applies suction to the first vessel.

In an embodiment, a waste stream lean in carbon dioxide is discharged from the first vessel.

In an embodiment, the feed means includes a tank that receives feed gas during the period in which the feed means is prevented from entering either of the vessels.

In an embodiment, the fluid communication means allows fluid communication between the vessels when operation of the feed gas means and the suction pump is being changed from one vessel to another.

In an embodiment, the plant includes a filter that removes impurities such as aromatic species from the feed gas supplied to the vessels.

In an embodiment, the plant includes a filter that removes impurities from a product stream rich in CO₂.

In an embodiment, the plant includes a evaporative cooler to which the waste gas stream that is lean in carbon dioxide is fed to cool a cooling water.

In an embodiment, the suction pump is a liquid-ring vacuum pump that receives cold cooling water from the evaporative cooler.

According to the present invention there is provided a gas separation process for the separation of at least one gas species of a feed gas mixture from at least one other gas species in the feed gas mixture by utilizing a gas separation unit to produce a dry stream and a wet stream, the process comprising utilizing the dry stream to cool cooling water by evaporative cooling and in turn using the cooling water to cool a liquid ring vacuum pump and/or the following liquid ring compressor.

In an embodiment, the cooling water is cooled by evaporation in a packed column or a spray tower.

In an embodiment, the feed gas temperature ranges from 10° C. to 90° C.

In an embodiment, the feed gas pressure ranges from 1 bar·absolute to 2 bar·absolute.

In an embodiment, the cooled water is recycled between an evaporative cooler and the liquid ring pump/compressor.

In an embodiment, the cooled water is supplied from a direct contact evaporative cooler, used to cool the liquid ring pump/compressor.

In an embodiment, the gas separation unit is a pressure/vacuum swing adsorption unit or a membrane unit.

In an embodiment, the gas separation unit utilizes water adsorbable adsorbents/membranes.

### DETAILED DESCRIPTION

A first embodiment involves a multiple-step vacuum swing adsorption cyclic operation. The first step, also known as the feed step, is to introduce the CO₂-containing gas (with/without moisture) emitted from the process into an adsorber column or vessel at a pressure above ambient pressure in the range 0-10 bar·g but typically 0-1 bar·g. The adsorber vessel contains at least one adsorbent that can preferably adsorb carbon dioxide at the feed pressure and temperature. These adsorbents include zeolites, aluminas, silica gels, activated carbons, or any other solid granular material which is selective for CO₂ over the non-CO₂ species in the gas stream. The effluent gas from the adsorption step, also known as the waste gas here, is sent into waste tank then either vented or sent to downstream processing or sent to a gas/liquid contacting device to produce cold cooling water. Many adsorbents such as zeolites or aluminas or silica gel will also adsorb water from the gas stream. In these cases, the waste gas is dry and may be used for other purposes such as evaporative cooling. The adsorption step is followed by a co-current depressurization step, where the flow to the adsorber is stopped by switching off the solenoid valve, and effluent gas flows out into a second adsorption vessel which just finished its pressure reduction step (either evacuation or pressure let-down) and hence is at a low pressure. In this step, the vessel is depressurized and the overall gas purity is increased. The next step is to remove the CO₂ from the adsorbent by a reduction in pressure. This is done counter-currently to the feed direction by means of a vacuum blower or vacuum pump (if sub-ambient pressures are desired) or pressure letdown to atmospheric pressure. The CO₂ rich product gas is stored in a product gas tank and then recycled to the downstream process. The next step is counter-current pressurization (this is the complementary step to the co-current depressurization) to receive effluent gas from the vessel in the co-current depressurization step and this step not only increases the pressure but also cleans the top of the vessel by low concentration carbon dioxide effluent. Finally, a feed pressurization or waste pressurization is added to raise the vessel pressure to its feed value before repeating the cycle. These steps are repeated alternatively in a cyclic manner using multiple beds from 1 to 6. Importantly, unlike all previous CO₂ capture cycle which require a CO₂ purge step, the process described does not utilize this step. Surprisingly, we are able to produce >99% CO₂ product stream without the use of a CO₂ purge step. This saves on a CO₂ recycle compressor hence reducing process capital and operating cost.

In a variation of the first embodiment, the feed gas stream contains CO₂, air and moisture at a pressure of approximately 0 bar·g˜1 bar·g and a temperature of 10° C. to 40° C., where CO₂ is the adsorbable component. The adsorbent is selected from X or Y type zeolites.

In another variation of the first embodiment, the adsorption step has a duration of around 10 seconds, the co-current depressurization and the coupled counter-current pressurization have duration of around 2 seconds, the evacuation step has duration of around 10 seconds and the repressurization step has duration of around 2 seconds.

In another variation of the first embodiment, the flow direction in the depressurization step is co-current to the feed gas flow direction and the flow direction in the pressurization is counter-current to the feed gas flow direction.

In another variation of the first embodiment, the flow direction in the evacuation step is counter-current to the feed gas flow direction. The evacuation pressure is in the range of 2-50 kPa.

The embodiments do not include any reflux, either heavy product reflux (also known as purge) or light reflux (also known as waste rinse) and this process can be successfully utilized to separate and recover the carbon dioxide emitted from the filling bowl in the bottling plant of carbonated beverages. The feed gas stream processed contains a certain amount of moisture which is at saturated level at the filling bowl process. Furthermore, this invention can also be easily applied to other CO₂ recovery/removal applications with similar feed gas conditions, especially in the food and beverage industry.

In another variation of the first embodiment, the dry waste gas from the process is sent to a gas/liquid contacting device and used to cool cooling water. Cold cooling water is sent to a liquid-ring vacuum pump to promote the attainment of low vacuum pressure especially in the range 2-10 kPa.

According to an alternative embodiment of the present invention there is also an apparatus for serving the recovery purpose. The apparatus comprises:

(A) an inlet coalescing pre-filter for absorbing aromatics and other impurities in the emitted gas from the filling bowl, and such filter also increases the feed gas temperature entering the adsorber,

(B) a fixed adsorber vessel packed with at least one adsorbent which preferentially adsorbs the carbon dioxide from the gas mixture and the adsorber has an inlet and an outlet,

(C) means for depressurizing the adsorber vessel to reduce the adsorber vessel pressure and further concentrate the carbon dioxide,

(D) means for pressurizing the adsorber vessel with depressurizing effluent gas to clean the top of an adsorber vessel and increase the vessel pressure,

(E) means for evacuating the adsorber vessel to withdraw CO₂ from the vessel counter-currently and send to the product tank,

(F) a vacuum pump outlet heat exchanger to cool the product gas,

(G) a product filter to remove impurities before sending the carbon dioxide gas back into the filling bowl.

### BRIEF DESCRIPTION OF THE DRAWINGS

A preferred embodiment of the present invention will now be described with reference to the accompanying drawings, of which:

FIG. 1 is a flow diagram of the vacuum swing adsorption process and plant comprising two adsorber vessels;

FIG. 2 is a schematic chart illustrating an operating sequence of the vessels shown in FIG. 1; and

FIG. 3 is a flow diagram of an evaporative cooling process and plant in which a dry waste gas stream lean in carbon dioxide of the flow diagram in FIG. 1 is used to cool a cooling water that is in turn used to cool a liquid ring pump of FIG. 1.

### DESCRIPTION OF THE PREFERRED EMBODIMENT

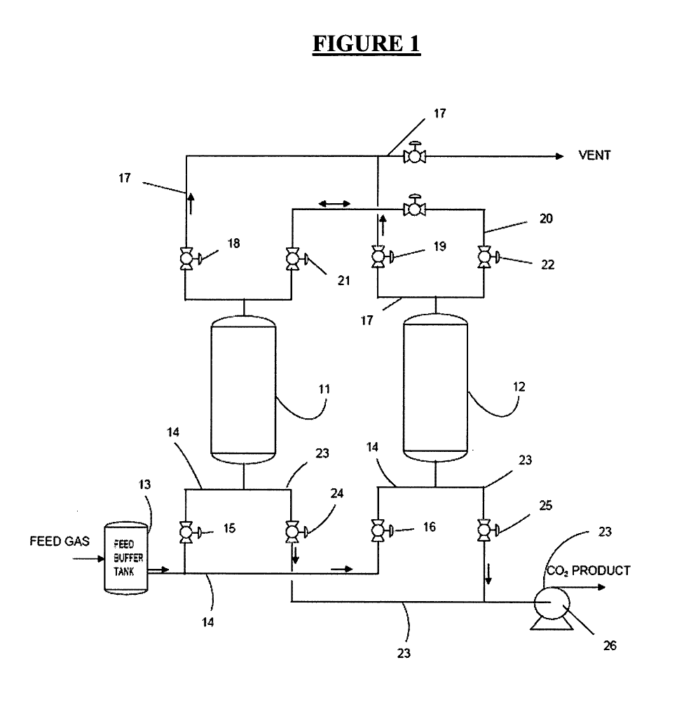

FIG. 1 illustrates a pressure swing adsorption plant and process suitable for recovering carbon dioxide from a waste gas emitted from the filling bowl of a bottling plant. The gas emitted typically contains from approximately 70%˜80% CO₂ by weight and is preferentially adsorbed onto a zeolite adsorbent. The adsorbent, preferably in the form of NaX, LiX or NaY, is packed into two adsorber vessels 11 and 12. The waste feed gas is feed to the vessels 11 and 12 via a buffer feed tank 13 and lines 14 containing control valves 15 and 16. A gas stream lean in CO₂ is discharged from the vessels 11 and 12 via lines 17 containing control valves 18 and 19. Once the adsorbent is loaded with carbon dioxide, a reduced pressure is then induced in the vessels 11 and 12 by means of a vacuum pump 26 connected to the vessels via lines 23 containing control valves 24 and 25. Line 20 containing valves 21 and 22 allows selective communication between the vessels 11 and 12.

As will be explained in more detail below, the vessels 11 and 12 are operated out of phase such that while the adsorbent is being loaded with CO₂ in one vessel 11 or 12, CO₂ is being desorbed in another vessel 11 or 12. In addition, co-current depressurization and counter-current pressurization of the vessels 11 and 12 is utilized to reduce power consumption and increase product purity and recovery.

The first step of the pressure swing adsorption process introduces the feed gas mixture containing 70%˜80% carbon dioxide at a temperature ranging from 10° C. to 40° C. and a pressure of 1 bar absolute ˜2 bar absolute into the vessel 11 via lines 14 and valve 15. Carbon dioxide is preferentially adsorbed onto the adsorbent and a CO₂ depleted stream (waste gas stream) is vented through the top of vessel 11 via line 17 and valve 18. It is envisaged that the first step would be carried in approximately 10 seconds. However, it will be appreciated that other periods for absorbing CO₂ can be used depending on flow rates and sizes of the vessels used.

The second step of the pressure swing adsorption process comprises depressurizing vessel 11 by means of the low pressure in vessel 12. In the situation of continuous operation of the process, vessel 12 will have been evacuated by pump 26 to a reduced pressure and depressurization of vessel 11 is achieved by interconnecting vessel 11 to vessel 12 via lines 20 and operation of valves 21 and 22. It is envisaged that the pressure in vessel 11 can be reduced to 60 to 80 kPa and a relatively small stream of CO₂ would be transferred to vessel 12. It is also envisaged that second step would be carried in approximately 2 seconds.

The third step of the pressure swing adsorption process comprises evacuating vessel 11 by operating vacuum pump 26 and valve 24. The pump 26 can reduce pressure in the vessel 11 to a pressure in the range of 2 to 50 kPa with valves 18 and 21 closed. A carbon dioxide enriched stream is withdrawn from vessel 11 and may then be conveyed to the product line for filling bowl use.

In addition during the third step, the feed gas mixture is fed to the vessel 12 via lines 14 and control valve 16 in a similar manner to the first step described above.

The fourth step of the pressure swing adsorption process comprises pressurizing vessel 11 by connecting vessel 11 to vessel 12 via line 20 such that a stream of gas flows in a direction from vessel 12 to vessel 11. It is envisaged that the fourth step will increase the pressure in vessel 11 to approximately 60 to 80 kPa and will be carried out in a period of approximately 2 seconds.

The final step involves a feed pressurization or waste pressurization to vessel 11 to raise the pressure in vessel 11. Once the pressure in vessel 11 is substantially equal to the feed gas pressure, the process can be continuously operated by repeating the sequence of steps described above as desired.

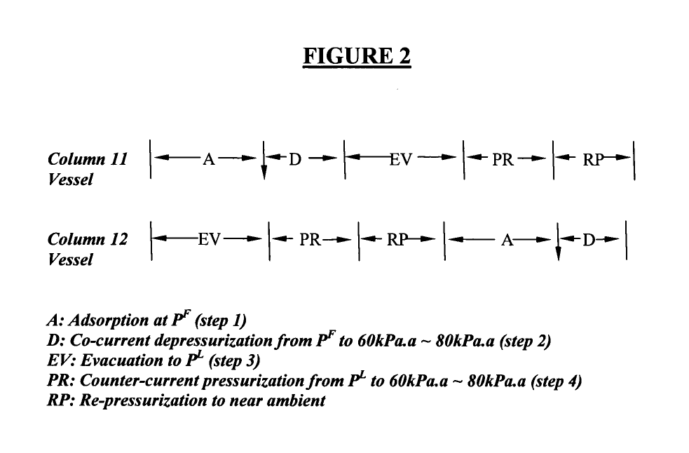

Indeed as shown in FIG. 2, steps involved with loading the adsorbent with CO₂ in the vessels 11 and 12 are represented by the letters “A”, “PR” and “RP”, and steps involved in desorbing or evacuating vessels 11 and 12 are represented by the letters “EV” and “D”. These steps are carried out in an out-of-phase sequence. In particular, while the adsorbent in one of the vessels 11 or 12 is being loaded with carbon dioxide, carbon dioxide is being desorbed from the adsorbent in the other vessel 11 or 12. Similarly depressurization of vessel 11 according to step 2, which is represented in FIG. 2 by the letter “D” also coincides with the pressurization of vessel 12, which is represented in FIG. 2 by the letter “PR”, “RP” and “A”.

In the situation in which the process is in the start-up mode, depressurization of the vessel 11 according to the second step may be omitted and the process may proceed from the first step to the third step.

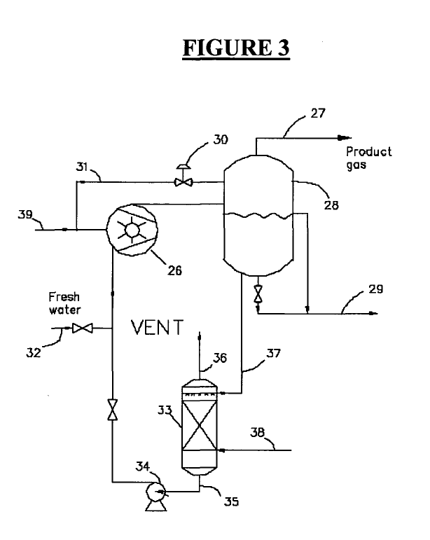

During the evacuation step, the product gas rich in carbon dioxide may be recovered by a liquid ring vacuum pump which utilizes a cold liquid water stream 35 produced by counter-current contact in a packed column 33 with a dry gas stream 38 generated during the gas separation process. The dry gas stream 38 in FIG. 3 is the waste product stream 17 in FIG. 1. The temperature of the liquid water stream 37 is decreased by evaporative cooling and returned to liquid ring pump 26 by water booster pump 34. The dry gas stream after passing through the packed column 33 may then be vented. Water vapour present in the product gas stream 39 is condensed in liquid ring pump 26 and consequently recovered in gas/liquid separator 28.

Unlike existing CO₂ capture processes which treat dilute CO₂ gas streams, the preferred embodiment described above does not include any reflux or rinsing, either heavy reflux or light reflux, while still producing high concentration CO₂ product.

The pressure swing adsorption process can be operated utilizing conventional pressure swing adsorption hardware. However, as the product gas has to satisfy food grade standard and also the mixture of CO₂ and water moisture has a corrosive effect, all the metal parts must be fabricated from or lined with stainless steel, including the vacuum pump.

A benefit of the preferred embodiment is that it consumes low power as it does not need a purge compressor and it can recover a significant amount of carbon dioxide from the emitted filling bowl gas, which is generally wasted.

Another benefit of the preferred embodiment is that it does not require water condensing equipment before the pump 26, and does not require refrigerated equipment to cool the water in the liquid ring pump. As the operating liquid temperature is decreased by evaporative cooling, better vacuum level and better performance are achievable. Meanwhile, the liquid ring pump also recovers a significant amount of water from the product gas stream.

### EXAMPLES

The present invention will now be described with reference to the non-limiting examples.

### Example 1

A pilot plant having the configuration shown in FIG. 1 was constructed. Each vessel had a diameter of 5.0 cm, a working length of 100 cm and was packed with 1.35 kg of packed zeolite NaX adsorbent. After obtaining experimental data, the process was scaled up and costed with the following parameters set:

| Feed Gas: | 75% CO₂, the remainder is air |
|---|---|
| | and saturated water |
| Feed pressure: | 1.21 bar. absolute |
| Vacuum pressure: | 0.3 bar. absolute |
| Product Purity: | >96% |
| CO₂ Recovery: | 55% |
| Power consumption: | 1.56 kW/TPD |
| CO₂ Productivity: | 3.688 ton/day |
| Adsorber number: | 2 |
| Adsorbent in total, kg: | 148.62 |
| Vacuum pump number: | 1 |

### Example 2

A simulation of a pressure swing process was conducted using a validated mathematical model of the PSA process. Each vessel had a diameter of 12.0 cm, a working length of 100 cm and was packed with 7.63 kg of packed NaX adsorbent. After simulation, the process was scaled up and costed with the following parameter set:

| Feed Gas: | 50% CO₂, the remainder is air |
|---|---|
| Feed pressure: | 1.21 bar. absolute |
| Vacuum pressure: | 0.13 bar. absolute |
| Product Purity: | 95% CO₂ |
| CO₂ Recovery: | 92% |
| Power consumption: | 1.68 kW/TPD |
| CO₂ Productivity: | 0.8 ton/day |
| Adsorber number | 3 |
| Vacuum pump number: | 1 |

### Example 3

A simulation of a pressure swing process was conducted using a validated mathematical model of the PSA process. Each vessel had a diameter of 7.7 cm, a working length of 100 cm and was packed with 3.14 kg of packed NaX adsorbent. After simulation, the process was scaled up and costed with the following parameter set:

| Feed Gas: | 78.49% CO₂, 1.88% N₂, 19.63% CH₄ |
|---|---|
| Feed pressure: | 3.0 bar. absolute |
| Vacuum pressure: | 0.10 bar. absolute |
| Product Purity: | 95.65% CO₂ |
| CO₂ Recovery: | 96.93% |
| Power consumption: | 2.92 kW/TPD |
| CO₂ Productivity: | 0.221 ton/day |
| Adsorber number | 3 |
| Vacuum pump number: | 1 |

### Example 4

A pilot plant having the configuration shown in FIG. 3 was constructed. A dry waste gas stream 38 that is lean in carbon dioxide is conveyed through a packed column 33 to conduct evaporative cooling to cool the cooling water 37 used in a liquid ring pump 26. As a result, the cooling water temperature is dropped.

| Inlet water: 20° C. | |
|---|---|
| Inlet dry gas stream: 30° C. | dewpoint <- 50° C. |
| Outlet water: | Gas/Liquid ratio |
| 11.01° C. | 1639 |
| 15.00° C. | 835 |
| 20.13° C. | 415 |

Correspondingly, the ultimate pressure in the vacuum pump for a given temperature is as follows:

TABLE 1

| | | |
|---|---|---|
| 13° C. | => | 38 mbar |
| 15° C. | => | 40 mbar |
| 17° C. | => | 43 mbar |
| 20° C. | => | 46 mbar |
| 25° C. | => | 55 mbar |
| 30° C. | => | 62 mbar |
| 35° C. | => | 75 mbar |

Performance data based on a generic vacuum swing adsorption cycle are respectively:

TABLE 2

| Pressure | Purity, % | Recovery, % | Power, kW/TPDc |
|---|---|---|---|
| 3.8 kPa | 99 | 98.21 | 2.292 |
| 4.6 kPa | 99 | 97.70 | 2.186 |
| 4.6 kPa | 99 | 97.70 | 2.186 |
| 5.5 kPa | 99 | 97.17 | 2.089 |
| 6.2 kPa | 99 | 96.83 | 2.031 |
| 7.5 kPa | 99 | 96.29 | 1.971 |
| 10.0 kPa | 99 | 94.22 | 1.839 |
| 20.0 kPa | 99 | 83.56 | 1.796 |
| 30.0 kPa | 99 | 61.88 | 2.519 |

Therefore, by cooling the water used in liquid ring pump without using extra refrigerating power, better vacuum levels are achieved, as well as better performance.

Those skilled in the art of the invention will appreciate that many variations and modifications may be made to the specific embodiment and examples without departing from the spirit and scope of the invention.

It is to be understood that, if any prior art publication is referred to herein, such reference does not constitute an admission that the publication forms a part of the common general knowledge in the art, in Australia or any other country.

1. A pressure swing adsorption process for recovering carbon dioxide from a feed gas stream, the process including the steps of:
a) adsorbing CO₂ onto an adsorbent from a feed gas stream at a particular or known pressure so as to convert the feed gas stream into a waste gas stream that is lean in carbon dioxide, and the feed gas contains CO₂ at an amount equal to, or greater than, 50% by weight; and
b) desorbing CO₂ from the adsorbent loaded with CO₂ in step a) by exposing the loaded adsorbent to a pressure below the pressure of the feed gas so as produce a stream that is relatively rich in CO₂;
wherein the process is conducted without purging or rinsing loaded adsorbent of step a) with a high purity carbon dioxide gas stream as an intermediate step between steps a) and b).

2. The process according to claim 1, wherein the process is carried out without purging or rinsing loaded adsorbent of step a) with a high purity carbon dioxide gas stream containing at least 90% CO₂ by weight as an intermediate step between steps a) and b).

3. The process according to claim 1, wherein the feed gas stream contains equal to, or greater than, 70% CO₂ by weight.

4. The process according to claim 1, wherein the feed gas is fed to the absorbent at a pressure ranging from atmospheric pressure to 10 bar gauge.

5. The process according to claim 1, wherein the feed gas exposed to the adsorbent is at a temperature of less than or equal to 100° C. and suitably, in the range from 10 to 40° C.

6. The process according to claim 1, wherein step a) is carried out for a period of at least 5 seconds and suitably in the range of 5 to 15 seconds and even more suitably approximately 10 seconds.

7. The process according to claim 1, wherein the feed gas stream is a gas emitted from the filling bowl of a carbonated drinks bottling plant.

8. The process according to claim 1, wherein the rich product stream contains equal to, or greater than, 90% CO₂ by weight and suitably, equal to, or greater than, 95, 98 or 99% CO₂ by weight.

9. The process according to claim 1, wherein step b) involves exposing the adsorbent to pressure below atmospheric pressure, and suitably exposing the adsorbent to pressure in the range of 2 kPa absolute to 90 kPa absolute, and even more suitably in the range of the 2-50 kPa absolute.

10. The process according to claim 1, wherein step b) is carried out for a period of at least 5 seconds and suitably in the range of 5 to 15 seconds and even more suitably approximately 10 seconds.

11. The process according to claim 1, wherein the adsorbent is contained in two or more than two vessels and steps a) and b) are carried out in one vessel according to a cycle and steps a) and b) are carried out in another vessel according to the same cycle but out of phase thereto.

12. The process according to claim 11, wherein the process includes a further step of interconnecting the vessels in fluid communication after steps a) and b), or immediately after steps a) and b) have been carried out on either one of the respective vessels.

13. The process according to claim 11, wherein the process includes interconnecting the vessels in fluid communication in which at least one of steps a) and b) is at the end of being carried out (or has been completed), whereby when step a) has or is being carried out in one of the vessels, communication between the vessels facilitates at least partial depressurization of the respective vessel from the operative pressure of step a), and when step b) has or is being carried out in one of the vessels, communication between the vessels facilitates at least partial repressurization of the respective vessel from the operative pressure of step b).

14. The process according to claim 12, wherein the vessels are connected in the fluid communication between each cycle of adsorbing and desorbing of CO₂ for a period of at least 1 second, and suitably in the range of the 1 to 4 seconds and even more suitably approximately 2 seconds.

15. The process according to claim 1, wherein the waste gas stream is directly contacted with a cooling water in a gas/liquid contacting device to cool the cooling water through the evaporative power of the waste gas stream.

16. The process according to claim 15, wherein the cooling water is used to cool a liquid cooled vacuum pump, such as a liquid-ring vacuum pump, which is operated to carry out, at least in part, desorption of CO₂ according to step b) by pressure reduction.

17. The process according to claim 16, wherein the cooling water is recycled between the gas/liquid contacting device the liquid cooled vacuum pump.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A gas separation process for the separation of at least one gas species of a feed gas mixture from at least one other gas species in the feed gas mixture by utilizing a gas separation unit to produce a dry stream and a wet stream, the process comprising utilizing the dry stream to cool cooling water by evaporative cooling and in turn using the cooling water to cool a liquid ring vacuum pump and/or the following liquid ring compressor.

35. The process according to claim 34, wherein the water is cooled by evaporation in a packed column or spray tower.

36. (canceled)

37. The process according to claim 34, wherein said feed gas temperature ranges from 10° C. to 90° C.

38. The process according to claim 34, wherein said feed gas pressure ranges from 1 bar·absolute to 2 bar·absolute.

39. The process according to claim 34, wherein said the cooled water is recycled between an evaporative cooler and the liquid ring pump/compressor.

40. (canceled)

41. The process according to claim 34, wherein the gas separation unit is a pressure/vacuum swing adsorption unit that utilizes water adsorbable adsorbents or a membrane unit that utilizes water absorbable membranes.

42. (canceled)
